(19) United States
(12) Patent Application Publication
(10) Pub. No.: US 2016/0180721 A1
(43) Pub. Date: Jun. 23, 2016

(54) SYSTEM AND METHOD FOR TRACKING, SURVEILLANCE AND REMOTE CONTROL OF POWERED PERSONAL RECREATIONAL VEHICLES

(71) Applicant: Ivan Otulic, Nijivice (HR)

(72) Inventor: Ivan Otulic, Nijivice (HR)

(21) Appl. No.: 14/874,126

(22) Filed: Oct. 2, 2015

Related U.S. Application Data
(60) Provisional application No. 62/059,532, filed on Oct. 3, 2014.

(51) Int. Cl. G08G 9/02; B60R 25/04; G05D 1/02; B60Q 9/00; B63H 25/02; G08G 3/02; G05D 1/00

(52) U.S. Cl. CPC G08G 9/02; G08G 3/02; B60R 25/04; G05D 1/0022; B60Q 9/00; B63H 25/02; G05D 1/0206; G05D 1/0289; B63H 2025/028

(57) ABSTRACT

A system for tracking and remote control of a personal recreational vehicle has at least two sensors. Each sensor senses at least a respective and distinct one of temperature, pressure, acceleration, geoposition orientation relative to a horizontal plane and communication signal strength. A microcontroller receives inputs from the at least two sensors, and determines whether a change in environmental conditions in which the personal vehicle is operating has occurred. The microcontroller sends an alarm to a user of the personal recreational vehicle if a change in the environmental conditions have exceeded a predetermined value.

### BACKGROUND OF THE INVENTION

This invention relates generally to recreational vehicles and more specifically to methods and systems to remotely control and analyze the operation of powered personal recreational vehicles, to include monitor their use and movement, analyze their operation and data, limit their speed, ensure they are operated safely, and limit the geographical area in real-time where said personal recreational vehicles are permitted to operate.

The technical problem that is solved by the present invention is the lack of an easy to use, real-time, fully integrated, accurate, reliable and flexible system for tracking, analytics, surveillance, management, remote control, risk elimination and communication with and between powered personal vehicles, such as all-terrain vehicles (ATVs), snow mobiles, scooters, street legal vehicles, water scooters (e.g. JetSkis®, Sea Doos®, Wave Runners®, etc.), small boats, and other small water vessels.

A system for tracking, surveilling and remote controlling of one type of powered personal vehicle, namely, watercrafts, is known from the inventor's Croatian Patent Application No. HRP20120578, the system monitoring the position of water craft by mounting a device on a watercraft indicated with base stations, the server using bidirectional communication protocol, communication with the watercraft's electronic control module is established. The remote control in the system controls the speed limitation, assists in braking, and even forces turn-off of the ski. It may also activate an onboard buzzer to warn the rider of either unsafe or impermissible riding conditions.

The position of the jet ski is monitored from data sent by the installed device on each jet ski. A remote server receives, operates on and stores the data received from the jet ski. In this way, a user of the controller in the form of a mobile device having an interface for management of the system provides an overall speed limitation for the entire trip, slowing in certain situations as a function of data received such as going beyond a geofence, and buzzer activation for warning the rider that they have exceeded the ride time, ride distance or are acting in an unsafe manner. Additionally, the position and fuel level may be obtained by sensors for determining position and fuel level mounted on the jet ski.

This system has been satisfactory, however, it suffers from the disadvantage that it requires two hardware devices. Furthermore, the prior art instant braking system was a binary function and could only be done as an “on” or “off”, i.e., a hard stop; the same being true with throttle management. Furthermore, because of its use of the remote server, the reaction time between sensing a situation and providing instruction is a relatively long 2.5 or more seconds. This can result in an unsafe result, situation and at certain speeds, traveling far beyond the geofence area.

Another category of powered personal vehicles as used herein, includes neighborhood electric vehicles (NEVs) such as: motorized electric scooters, electric bicycles, electric street legal vehicles and the like, low speed vehicles (LSVs), which includes: statutorily speed restricted street legal small passenger-carrying vehicles, mopeds, go-carts, golf carts, scooters, mini-bikes, some motorcycles, as well as NEV vehicles. Some of these vehicles are regulated by State and Federal law which requires these vehicles to comply with certain mandates and requirements such as, not being able to travel beyond a predetermined speed such as 25 miles per hour.

These vehicles have been satisfactory for their intended purpose. However, an aftermarket industry has developed for increasing the speed of these vehicles. The aftermarket includes detailed instruction manuals for tampering with and disabling governors and other currently known speed limitation systems, as well as the sale of replacement parts, wiring, micro-chips, engines and other devices to allow the vehicle to travel at prohibited speeds. As such, the manufacturer and owner cannot certify the vehicle complies with statutory and regulatory conditions, mandates and requirements.

Accordingly, an integrated system which can remotely and accurately monitor, analyze, track and control the use and operation of powered personal recreational vehicles in a smooth, seamless and tamper proof fashion across a wide range of parameters in less reaction time i.e. real-time, is desired.

### SUMMARY OF THE INVENTION

The subject invention resolves the above-described needs and problems by providing an integrated system to remotely and accurately monitor, analyze, track and control the use and operation of powered personal recreational vehicles in a smooth, seamless and tamper proof fashion across a wide range of parameters in real-time, which is comprised of a device for monitoring the position of a powered personal recreational vehicle mounted on the vehicle.

The on-board device has a microcontroller for communicating between a wide range of vehicle sensors such as sensors for: throttle state, fuel level, temperature, air flow, exhaust, r.p.m.s, engine performance parameters, memory card, and a variety of other sensors and the vehicle's engine control unit. The microcontroller, in response to data received from the wide range of various sensors and analysis thereof or instructions received from a remote device, controls the vehicle by sending control signals to the engine control unit. The microcontroller is continuously monitoring the sensors so that it may send control signals to the engine control unit across a range of values including but not limited to: controlling speed, regulating distance between vehicles, geo-limiting operation, tracking, and compliance. Additionally, the microcontroller, given data stored on-board the vehicle, may operate in the absence of signals from a remote device across a range of values.

The microcontroller runs an application for receiving and storing data from various on-board sensors about the status, position and movement of the personal vehicle. The microcontroller manages all aspects of the personal vehicle's operating processes, as well as management of constraints and recording of statistics and analytics. The microcontroller is in communication with a server via GSM modem, or other suitable wireless communication protocol, and the server may be a mobile device running a mobile device application that may also serve as a user interface for the management of the entire system.

The microcontroller may be in a module connected to a GPS receiver and interfaces with a variety of sensors, including at least a throttle sensor for sensing a throttle state as an input, and provides an output to the onboard engine control unit.

In one embodiment, one input to the on-board microcontroller is connected to the potentiometer, or other sensor, for fuel tank level. The GPS receiver is able to monitor the position of the vehicle at all times, and to collect positioning data for on-board use, as well as transmission to the base station and server, if desired, using methods that are known.

The system can also be used in such a way that the on-board microcontroller manages the whole system, or it can be managed from a mobile application running on an Android®, iPhone®, Windows® Mobile or similar mobile device platform.

Upon receipt of data at the on-board module, and in particular, the microcontroller, the microcontroller performs an analysis of same and ascertains the position and parameters of the personal vehicle, and according to a predefined algorithm determines the parameters that are used to identify the allowed position of the personal vehicle and the necessary commands that will be forwarded by server application to the personal vehicle.

All received data may be stored in an on-board memory, as well as an SQL database on the off-vehicle server. The database contains tables for various parameters and data (e.g., table of basic parameters for each that contains information about latitude, longitude, speed and direction of craft, database time of entry, etc.).

One or more geographic zones may be stored in the memory of the module. This geographic zone corresponds to a physical area in which the craft is permitted to operate. The module includes a GPS input and compares the current position of the vehicle to the geographic zone. If the vehicle travels outside of the geographic zone, then the module causes the vehicle to indicate to the user that they are outside of the zone. This may take the form of an audible signal, sending a signal to the engine control unit to reduce the speed of the vehicle for a predetermined time period, or even to turn off the engine for a predetermined time period.

In another embodiment of the invention, collisions and contact between vehicles may be avoided by a second vehicle having a second module thereon with its own GPS sensor, the module operating in a similar manner to that discussed herein; the modules determining when the first vehicle reaches a predetermined distance that is considered unsafe at a predetermined speed, manner of operation or direction of travel, from the second vehicle and each module controlling each respective vehicle to avoid contact and a crash. A control may be an audible signal to get the attention of the user, a signal to the engine control unit to slow down the vehicle or stop the vehicle, particularly in the case of watercraft.

In a preferred embodiment, the control and managing logic for monitored vehicle operation uses the following algorithm:
Once a user begins driving the vehicle, a drive counter integrated into the module begins to track the time of use and operation and where the operation is performed within a first geographic zone, geo1, speed limits may be set, and in a second geographic zone, geo2, the module may set no operational limit parameters. If the vehicle travels outside geo1 and geo2 zones, then the vehicle may receive, from the server, a signal which reduces speed, sounds an alarm or turns off the vehicle for a predetermined time period as a warning to the driver that the vehicle is outside the permitted zone of operation or otherwise exceeded permissible operation.
The module may determine that an allotted amount of use of the vehicle has ended or is about to end. The server then sends a signal to reduce speed, sound a warning or a shutdown signal for a different predetermined amount of time, as a warning to the driver that the allotted permissible use of the vehicle has ended. To operate efficiently, the signal may also be calculated as a function of distance from return area to account for total operation time.

Vehicle riding statistics are recorded in an SQL database on the server and can be reviewed at the mobile device. Usually the recorded data includes data about driving time, authorized use, promotional (free) rides, and unauthorized rides. It also enables real-time analysis, control, analytics, and search, of the vehicle's use, operation, statistics and data according to different parameters.

The system is designed so that by using basic text commands via the mobile device, some of the following commands can be sent directly to the module:
turning on/off command for a craft/vehicle
general reset of the module governing parameters
partial reset the module governing parameters
turning on/off warning signal
sending signals or messages to the craft/vehicle

The application on the mobile device is designed so that during its startup a main menu is displayed, which includes a display status of all vehicles being monitored in a particular location or geographic area. For each vehicle, various information and data about each can be shown and displayed in real-time and it is also possible to run various real-time reports, analysis, statics, and analytics on the data and information stored in the SQL database server.

Furthermore, the application contains a detailed listed form which is divided into three segments: a segment for inputs and outputs management, a segment for advanced information and a segment for information. Each segment shows a certain type of information about a craft/vehicle status and position.

These and other objects, features, benefits, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

The present disclosure is better understood by reading the written description with reference to the accompanying drawing figures in which the reference numerals denote the similar structure and refer to the elements throughout in which:

FIG. 1 shows a schematic view of the components of a system for monitoring vehicles in accordance with the disclosure;

FIG. 2 is a schematic view of the various components and connections between the module and vehicle subsystems, constructed in accordance with the disclosure;

FIG. 3 is a schematic diagram of a module for controlling and monitoring a powered personal recreational vehicle constructed in accordance with the disclosure;

FIG. 4 is a schematic diagram of the geographical zones in which a vehicle, particularly a watercraft, would operate in accordance with the disclosure;

FIG. 5 is a schematic diagram for the operation of the system to allow a first vehicle to control the operation of one or more other vehicles in accordance with the disclosure;

FIG. 6 is a schematic view of an embodiment of the system to prevent two vehicles being monitored by the system from contacting or colliding with each other; and

FIG. 7 is a schematic diagram for utilizing the system to obtain photographs in accordance with a further embodiment of the disclosure.

### DETAILED DESCRIPTION OF THE PREFERRED EMBODIMENT

While the present invention will be described more fully hereinafter with reference to the accompanying drawings, in which an embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

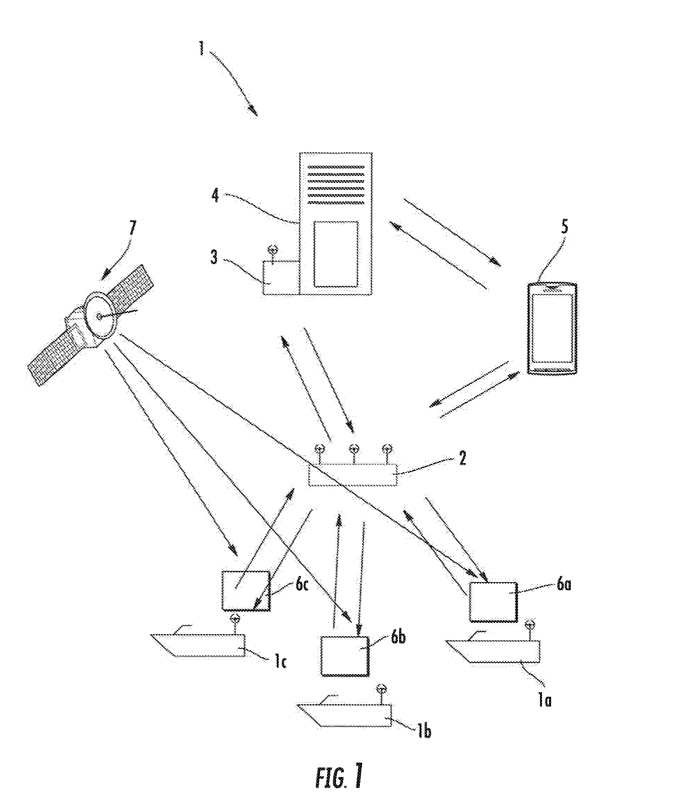

Reference is now made to FIGS. 1-3 in which the basic operation of the system is provided. While the invention is generally applicable to powered personal recreational vehicles, such as ATVs, small watercraft, snow mobiles, scooters, small passenger-carrying vehicles, NEVs, LSVs and the like, for ease of simplicity of description, the invention is described in connection with a personal watercraft embodiment such as a jet ski. The system is applicable to monitoring a single watercraft 1 or a plurality of watercraft 1a-1c by a single user utilizing a single server 4 for or mobile device 5.

As seen in FIG. 1, system 10 monitors and controls one or more jet skis 1a-1c. A respective module 6a-6c is mounted on each jet ski 1a-1c, the module 6 monitoring the position of the respective jet ski 1 and controlling the jet ski 1 in response to input signals, as will be discussed below. Each module 6 is mounted on a respective jet ski 1 in a manner that is well protected from water exposure, preferably, in a waterproof chassis in the front of jet ski 1. System 10 has the capability to communicate with a GPS satellite 7 to determine the position of each jet ski 1a-1c having a respective module 6a-6c thereon.

System 10 also includes a server 4 for assisting in the control of jet skis 1a-1c, and having a memory for storing data/information about the operation of each jet ski 1a-1c as known in the art, both historically and in real-time. Server 4 includes a transmitter/receiver 3 (transceiver) for communicating with the various elements of system 10. In a preferred, but non-limiting embodiment, transceiver 3 utilizes a Global System for Mobile Communications (GSM) protocol, and receives signals directly from modules 6a-6c, but may operate utilizing TCP/IP communication protocols in order to communicate with a jet ski 1.

As seen in FIG. 1, a base station 2 may be provided to receive signals from modules 6a-6c. However, additional communication elements within the systems such as sub station 2 are contemplated for use as GSM repeaters or RF transceivers to enable the coverage of larger areas with minimum signal delay between the server and the modules on the jet ski 6a-6c. Such a base station 2 may be utilized in places where signal communication is poor, such as in a mountainous area, remote area or an area where there is a lot of competing telecommunication signals, such as a densely populated resort area.

A remote access device 5 such as a mobile smart phone, a tablet, or even a laptop with communication capabilities for communicating with system 10 is provided so that a user may control the monitoring and operation of jet skis 1a-1c.

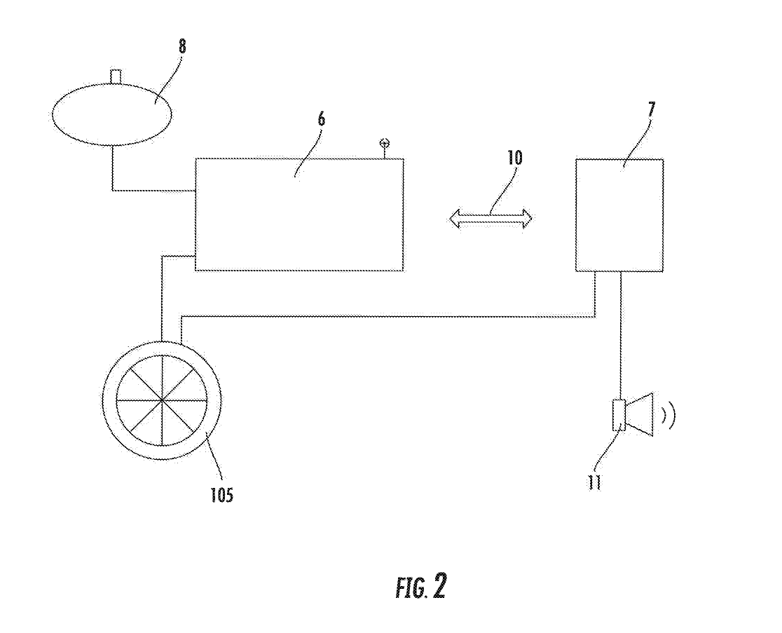

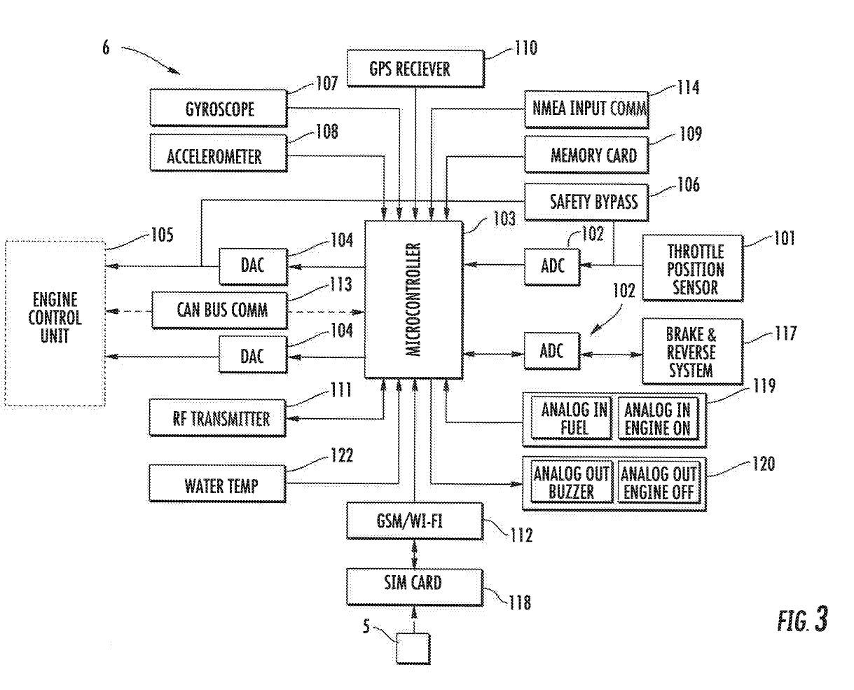

Reference is now made more particularly to FIGS. 2 and 3, in which the module 6 and its interactivity with elements of jet ski 1a are shown. By way of non-limiting example, jet ski 1 may be provided with a horn or buzzer 11. It may include a potentiometer 8 for monitoring real-time engine parameters. It may also include an engine control unit 105. In one mode of operation, module 6 receives inputs from potentiometer 8, and in response to such inputs, may provide outputs to engine control unit 105.

By way of example, potentiometer 8 determines the fuel level in a fuel tank of jet ski 1. At the same time, module 6 determines a geolocation of jet ski 1 by communicating with the GPS satellite 7 utilizing GPS receiver 110. Module 6 and/or 7 compares position to fuel level and determines whether there is sufficient fuel to return the jet ski 1 to its starting point or point of re-fueling. If not, then module 6 sends a signal to the user of jet ski 1 by way of buzzer 11 or a signal to engine control unit (ECU) 105 to control the speed or stop the engine entirely as a brief signal to the user. Module 6 may communicate with buzzer 11. However, if it is necessary to include aftermarket capabilities such as further control of the operation of jet ski 1, or the operation of the buzzer 11, then secondary module 7 may be added aftermarket to provide expanded capability. Module 7 operates in a manner similar to module 6 and may allow for aftermarket external accessories such as a Go Pro™ camera as discussed below.

Generally, module 6, and where required module 7, are powered by the on-board battery of jet ski 1 or in times of no vehicle power, via the power-stealing rechargeable battery. Modules 6 and 7 communicate with the various components of the jet ski that need to be monitored and/or controlled utilizing either analog or digital communication protocols as necessary. Modules 6 and 7 may be interconnected to the various devices by conventional wiring such as an RS232 wire interface as known in the art, or wirelessly as will be discussed below.

Modules 6 and 7 send outputs, when needed, to provide an audible alarm when conditions merit, or to provide signals to the engine control unit 105 such as to limit engine speed, or just to shut down the jet ski 1a entirely. As seen in FIG. 3, module 6 includes a microcontroller 103 for receiving signals from a plurality of sensors which may be considered part of module 6, or module 6 may be simply intercepting signals from preexisting sensors within jet ski 1a. By way of example, microcontroller 103 receives inputs from a gyroscope 107, an accelerometer 108, a GPS receiver 110 in communication with GPS satellite 7, and/or potentiometer 8. Microcontroller 103 also can retrieve data regarding previous uses of each respective jet ski 1 from a memory card 109 and monitors the throttle position utilizing a throttle position sensor 101. Memory card 109 may also store trip parameters such as a geofence for areas which are authorized or unauthorized for use, speed limitations, particularly within a geofence 216 or an overall limitation for safety, which will be used by microcontroller 103 to send signals to engine control unit 105.

As will be discussed in detail, module 6 may include a SIM CARD 118 for communicating with remote access device 5.

In response to all or some of the signals either together or alone, microcontroller 103 controls operation of an individual jet ski 1 by providing control signals to engine control unit 105 utilizing digital to analog signal converters 104 and controller area network business communicators 113. During operation, in one non-limiting embodiment, throttle position sensor 101 provides an analog signal to microcontroller 3 indicating its throttle position. The analog signal is routed through an analog to digital converter 102 where it is input to microcontroller 103 as a digital signal. Microcontroller 3 copies the signal and sends it to digital to analog converter 104 sending an analog signal to engine control unit 105. Microcontroller 103 normally will not interfere with this normal operation of jet ski 1a.

It should be noted that signals processed by inverters 102 and 104 are in a preferred embodiment analog or digital inputs converted to digital or analog outputs respectively as described herein. However, one skilled in the art would understand that these are merely input signals that comply with the conventional industry standards as the invention was developed and that any signal having the information discussed herein would be within the scope of the invention.

Other inputs are received by microcontroller 103 from the other sensors discussed above, and utilizing a National Marine Electronics Association (NMEA) input communication protocol for connecting marine sensors to microcontroller 103. Utilizing an NMEA input communication bus 114, various engine data parameters are monitored. Microcontroller 103 is constantly analyzing information from gyroscope 107 (to determine direction), accelerometer 108 (to determine speed), memory card 9 (which may include an offline map data, as well as other operational parameters), GPS receiver 110 (for determining position of vehicle), RF transmitter 111, and GSM/Y-5 receiver 112 to communicate between remote access device 5 and jet ski 1a, and between individual jet skis 1a-1c. Any unexpected values from these inputs, as determined by comparing the received data with the parameters such as maximum speed, authorized direction, authorized geofence area, stored in memory card 9, 10 will cause microcontroller 103 to control the operation of vehicle 1a by providing control signals to engine control unit 105. This may be a reduction of the throttle position sensor 101 input signal which will immediately limit jet ski 1a's speed or even outputting a command to temporarily shut down the engine.

Microcontroller 103 outputs these signals to digital to analog converters, or to a controller area network (CAN) bus communication 113 to control engine control unit 105. This allows for safety critical features and for protecting jet ski 1a from over speeding, by way of example, where the analog signal value between the throttle position sensor 101 is a smaller value than the one between microcontroller 103 and engine control unit 105, by way of non-limiting example. The trigger event may be leaving the geofenced area, being too close to other craft 1a-1c, or exceeding a speed as determined by the accelerometer 108 or as a warning that fuel is low as determined by sensor 120.

From data collected from the combination of sensors, the microcontroller 103 can create a map of GSM operator signal coverage, temperature and pressure maps of the areas in which jet ski 1 is moving. Memory 109 or the server 4 collect historical data from the Global Positioning System (GPS)/Global Navigation Satellite System (GLONASS) elevation, pressure and temperature in order to forecast events, tides, changes in weather conditions or the like. Outputs from accelerometer 108 and gyroscope 107 can detect differences in wave activity and along with other weather sensors such as water temperature sensor 122 can forecast incoming storm activities. Module 6 is constantly logging all this data. Server 4 may set extreme conditions such as maximum/minimum value for the sensors and when these conditions are triggered, server 4 or microcontroller 103 may send notifications to the user that something is out of order, and that jet ski 1 should be brought back to its origination or to a place of shelter or authorities notified.

Alternatively, and/or simultaneously, the data received at microcontroller 103, such as the inputs from gyroscope 107, accelerometer 108, and GPS receiver 110 is sent to server 4 utilizing GSM/Wi Fi transceiver 112 or to other modules 6b-6c equipped jet skis 1b-1c utilizing RF transmitter 111. In this way, an operator utilizing remote access device 5, preferably a mobile device, can send a control signal through SIM CARD 118 and GSM/Wi Fi 112 to microcontroller 103 to output a control signal such as slow down, speed up or shut off, to engine control unit 105.

Microcontroller 13 is constantly monitoring and analyzing information coming from the various sensors. The data may also include a latitude, longitude, reading time, vehicle speed, direction of movement, voltage from the external power source, voltage of an internal power source such as a battery, GPS and GSM signal strengths; status of the digital signal inputs, status of digital signal outputs, status of analog inputs. This data from gyroscope 107, accelerometer 108, and GPS sensor 110 by way of example, is sent to server 104 utilizing communications. By constantly analyzing jet ski 1's (or some other vehicle's) position, direction, speed and driving patterns, the system 10 may predict and mitigate the risk of accident, harm, or hazardous driving by applying the speed limits when necessary. Analysis of data may also be performed by microcontroller server or even mobile device 5.

Parameters for operation are stored in server 4 and/or memory card 109. Additionally, memory card 109 may be used for gathering relevant drive parameters during operation of jet ski 1 and act as an accident data recorder; a virtual “black box”. It may store geo-specific information such as speed limit zones, off limit zones, and other parameters to be discussed below to have additional safety redundancy in case server 4 is incapable of communicating with module 6 or there is server down time. The monitored parameters of jet ski 1, such as the position of jet ski 1 are set in a way so that a respective module 6 periodically sends the data to server 4. This may occur as a function of time or a function of distance. By way of non-limiting example, jet ski 1 is in motion, the data may be sent at predetermined distance intervals, such as by non-limiting example, every 10 meters. If jet ski 1 is moving, or even when jet ski 1 is not moving, data may also be sent at predetermined periodic time intervals such as, by way of non-limiting example, every 60 seconds.

The use in combination of data received from the sensors may be used both as a safety device, or as described in greater detail, an anti-theft device. By way of example, accelerometer 107 is repeatedly read at a rapid rate. In one non-limiting example, accelerometer may be read 33 times per second so that any anomalous inputs can be compared by microcontroller 103 to expected input values. Sudden movements can be recognized through pattern recognition much as humans recognize different inputs correspond to different situations. For example, if there is constant uniform movement from waves or the like, that pattern is learned and stored in memory 109 and/or server 4. When there is a sudden change in force or direction of movement relative to the constant uniform movement, then microcontroller 103 determines that something is different. By way of non-limiting example, jet ski 1 is pulled out of the water to come to a complete stop as acceleration in one direction relatively up and then zero acceleration in other directions. If jet ski 1 is driven, microcontroller 103 will recognize acceleration in one direction. If it is towed on the back of a truck, then there will be jumps from the road, sidewalks or the like, up/down, left/right, and small lasting but stronger forces. If there is a crash, accelerometer 108 will register a single large force in the direction of the crash/travel. All different recognizable situations can trigger notifications or other alarms and reporting to server 4 and/or remote access device 5.

Capsizing can be detected by the use of gyroscopes and accelerometers. Accelerometer 107 detects earth gravitational forces. In a tip over situation, the gyroscope will have changed its bearing 180 degrees. This in combination with the accelerometer showing gravity inverted indicates a tip over. Therefore, jet ski 1 is turned over or to the side and this event lasts longer than a given known period of time then server 4 can notify any person that jet ski 1 is turned over and that the driver needs attention or to be rescued. The same is true in a crash or other emergency situation.

To accommodate the storing, manipulation and operation on even more data, expansion module 7 may be provided for monitoring the position of jet ski 1, the current state of inputs and outputs to module 6 are internal to module 6, and data regarding the proper operation of module 6. The raw data is transmitted to server 4 upon which an application is provided for analyzing the position and parameters of jet skis 1a-1c.

The received data are stored in a database such as an SQL database associated with server 4 as known in the art. Server 4 may establish certain tables for manipulating and sorting the stored data. One table may correspond to the basic parameters associated with each watercraft 1a-1c. This data may include latitude, longitude, data time, speed on average in real time, direction, and the time at which the data is entered into the database.

In an environment where the jet ski 1a is a leased jet ski 1a, an identification name and/or number may be assigned to each jet ski 1a. Server 4 may track drive time, operational data, whether there is an over run of use time, and database entry time, as a separate table. Where promotional rides are offered, a promotional ride table may be stored as a database with the watercraft identification such as a name or number associated with a single craft, starting and ending time of the ride and daily usage both in real-time and in allowed time, are part of that table. A table may be created and stored corresponding to unauthorized rides for all of jet skis 1a-1c. This table would include the watercraft identification, the starting time of each unauthorized ride, and the ending time of each unauthorized ride. Unauthorized ride as will be seen below, primarily corresponds to time of use and/or the geographic location of use, i.e., outside of the geofence and/or outside of the operating hours of the person or company responsible for operating jet skis 1a-1c. An additional table may be a table of occurrences which stores by jet ski 1, the ride and event occurrence such as the beginning of a ride, a violation of one of the parameters, the time of the occurrence, and the state of the system. All can be sorted and displayed in real-time per jet skis, per operational location so that the person or company responsible for operating jet skis 1a-1c can visualize, monitor and manage the watercraft in real-time across all locations.

For a number of reasons, communication between server 4 and module 6 may become disrupted. However, a jet ski 1 in open water still must operate, and operate in a safe manner as intended by the jet ski operator. For this reason, and in a preferred, non-limiting embodiment, first an offline map is stored in memory 109. Microcontroller 103 can use the map stored in memory 109 and GPS inputs from GPS receiver 110 to determine a position and enforce the geofencing and other controlling capabilities described above and below of module 6a. Furthermore, upon determination that the signal has been lost for a predetermined period, as a safety precaution, microcontroller 103 can use a separate set of parameters for such situations stored in memory 109 which may be different than the communication enabled parameters; as a function of determining communication has been lost. These parameters may include slower speeds in certain geozones, maybe even a shortened authorized time period.

Hours of inactivity such as during darkness, may be stored at server 4 or memory card 109. Because both microcontroller 103 and server 4 may include a clock for determining and tracking real time, as known in the art, each may compare the inactivity hours to the actual time of day, send a signal either to, or within, module 6 preventing operation of engine control unit 105 during such off use hours. Microcontroller 103 will not send a signal to any part of module 6 to operate while it is in such a “sleep” or “no use” mode, which is a function of the reading from the input of the real time clock. The signal may indicate to module 103 “do not operate until you receive a follow-up signal to operate” or “do not operate before a predetermined real time such as 9:00 AM”. The person in ultimate control of system 10 may always send an override signal to module 6 utilizing server 4, remote access device 5, or some other communication means at any time if a use of jet ski 1 is desired in an off hour.

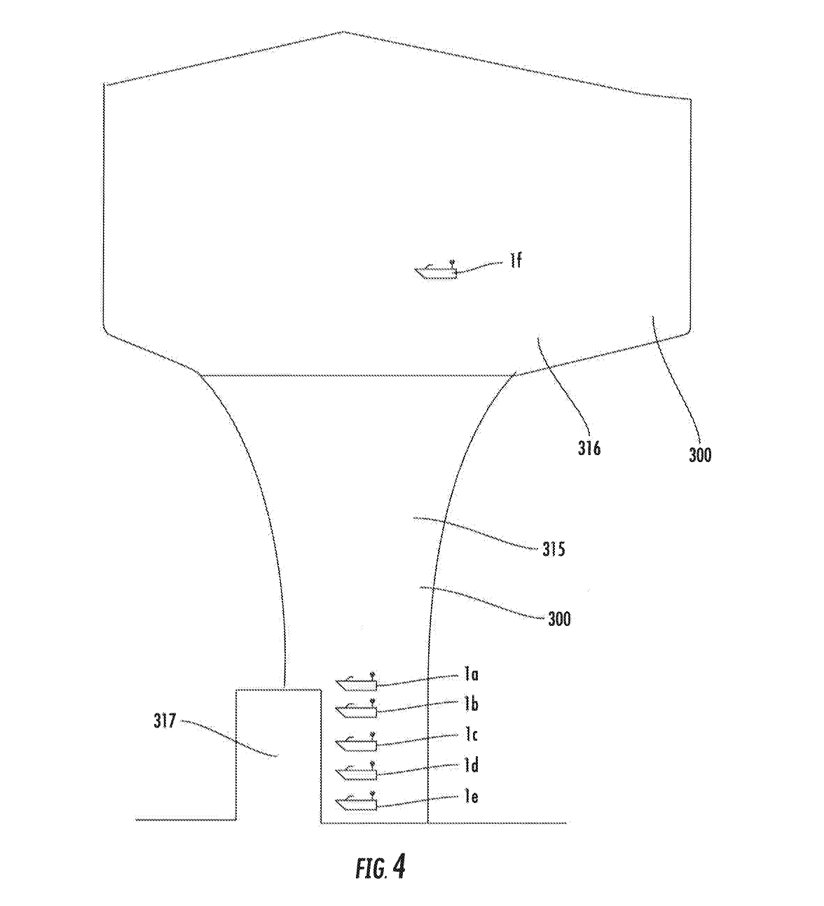

Reference is now made to FIG. 4 in which operation of the system, in one method of operation, a geofence operation, is provided. When controlling the use of jet ski 1 by novices, children, or by renters at a commercial environment, it is desirable to control the area in which the jet ski 1 may be operated, the parameters of the operation of jet ski 1 within distinct regions within the overall geophysical location of the geofence and hours of operation. By way of example, one may not want their children to be able to travel more than a mile from the shore or along the shore so that it is easier to monitor jet ski 1, both visually and electronically. Additionally, in many environments, there may be different parameters within a single geofenced area as a function of location within the geofence or multiple geofence areas with different parameters linked together as a controlled pathway, tour or trail. By way of example, one may want to create a controlled operational pathway though a body of water or channel with hazardous, protected or environmentally restricted areas.

As seen in FIG. 4, a single geofence area may have two or more distinct regions, a first region 315 which is a first geozone and a second region 316; the second geozone. Geozone 315 includes the mooring 317 for jet skis 1a-1e at which a trip may begin. As is known under most maritime laws and customs, geozone 315 containing mooring 317 is normally a no wake, low speed zone. Furthermore, it is usually a relatively narrow zone to avoid other moors, other boats, swimmers or the like. Therefore, the parameters for geozone 315 stored in modules 6a-6e of a respective jet ski 1a-1e will have a maximum speed in accordance with local custom and/or law, which will be significantly lower than the maximum speed in geozone 316 which is far away from the crowded mooring geolocation 315. The parameters for the second geozone 316 are more in line with the recreational use, and in some cases, open throttle operation of a jet skis 1a-1e may be allowed.

Generally, if module 6 of any respective jet ski 1a-1e senses that a particular jet ski is operating outside of the parameters, such as speeding in zone 315 or operating outside of geofence 300, it may send a signal to engine control unit 105 to lower the speed to within the permitted speed limit, turn off the engine as a warning, or to prevent further escape from the geofence area, or may send a signal to buzzer 11 as a warning to the user to control their manner of operation. Alternatively, module 6 may send a signal to mobile device 5 indicative of the actual or potential (as a function of a pattern of parameters) violation of the parameters so that remote device 5 can send a command to control a particular jet ski 1a by way of example.

In one further embodiment, a user may utilize mobile device 5 to create and assign parameters for each geozone 315, 316. In one preferred embodiment, remote device 5 downloads a map onto a screen of mobile device 5. The map would include the basic desired geolocation of each watercraft 1a-1e including the mooring location. With graphical user interface (GUI) as known in the art, the user then inputs a desired geophysical location as a geofence 300 by using for example, a stylist or a finger on the touchscreen. The user may divide the image into two or more regions. Once the map has been drawn, the user assigns parameters to each of the newly drawn zones integrating them into system 10 and storing them on mobile device 5, server 4, and within modules 6a-6e. The regions may be linked together in a manner to create a controlled tour or trail.

During operation, jet ski 1 is situated at a mooring or dock 317 within the first geographical zone 315. In this example, geozone 315 is a low speed narrow area geozone to ensure the safety of other vehicles and nature and, in some environments, swimmers or waders, who may be in the area or near the area. Once operation of jet ski 1 begins, a drive counter or timer within microcontroller 103 begins counting an elapsed time. The trigger may be an input from engine control unit 105 or throttle position sensor 101 to begin the counting process. At the same time, microcontroller 103 is comparing the current position of jet ski 1, as determined from GPS sensor 110 and/or the data from gyroscope 107 and accelerometer 108 to the geofences 315, 316 as stored in memory card 109. When microcontroller 103 determines that jet ski 1 is outside of the geofence area, module 6 sends a signal to the user of jet ski 1. This may take the form of a signal to engine control unit 105 to slow down jet ski 1, turn off jet ski 1 for a predetermined amount of time, or send a signal over buzzer 11. The predetermined shut down period may be four seconds by way of example, a time period sufficiently different from other signals so that the user understands not only that something is wrong, but what is wrong (their operation of the craft).

It should be noted, that this functionality may also be performed utilizing server 4 and the signals indicative of ride time being output directly to server 4 or to mobile control device 5. At that point in time, the operator of mobile device 5 may determine whether they wish to override the control signal to allow additional time to the user of jet ski 1. Microcontroller 103 is continuously comparing the elapsed time count to the ride length parameter as stored in memory 109.

It also follows, that in some embodiments of the invention the geofence 315, 316 would be irrelevant. For example, in a promotional ride in which the owner of a jet ski 1 wishes to give a user of jet ski 1 unlimited access to test the full range of capabilities of jet ski 1. Therefore, there is no need for geolocation analysis and limitations. An unauthorized run is the opposite in which the jet ski use was not confirmed by the owner of jet ski 1, but because the user is complying with the same rules as every other user, the server 4 or owner utilizing mobile device 5 may override the parameters and controls in microcontroller 103 and allow the use to continue. Even non-promotional rides may be without geofences 315,316 if the owner of the jet ski is the actual rider, or has enough faith and trust in the user, such as an adult to allow use of jet ski 1 beyond any geofence.

Through the use of a database, such as an SQL database, system 10, at server 4, is capable of monitoring, storing, analyzing and manipulating data received from module 6 at a level even more broken down than discussed above. For different use sessions, a use session being a use by a single unique user, or prearranged group of users, such as a family, use statistics may be stored at the database on server 4 to track things like the number of rides at predetermined time intervals such as the number of rides that were 10 minutes long, 15 minutes long, 30 minutes long, an hour, or the like. The number of promotional rides and the length of the ride may be determined by server 4 by comparing the beginning of the ride to the count at the end of the ride or the time on a clock at the end of the ride. Similarly, the same statistics can be stored for unauthorized rides or other rides as defined by the person in ultimate control of system. This data can be made to create tables that can be displayed in real-time per jet ski, per location, as discussed above.

Mobile device 5 is able to access the data stored at server 4 and to make use of the data stored at server 4. Mobile device 5 enables a user to research and analyze the overall rides of watercrafts 1a-1e or each of jet skis 1. Mobile device 5 first displays a main menu which includes a display status of all jet skis 1a-1e in a particular location. For each jet ski, various information about the jet ski can be shown such as the jet ski identifier (name), a ride counter, the status of the jet ski (on/off), the current speed of each jet ski, or an error message if there is a failure to connect utilizing the GSM network 112, even the relative position of each jet ski 1a-1d in the geofence area as objects on a map as shown in FIG. 4.

Furthermore, summary data may be displayed at mobile device 5 in real-time as either generated by server 4, or even created on some mobile devices 5 having a sufficient microcontroller of their own. For example, the current daily parameters for each jet ski such as the number of rides, duration of each may be displayed. The total number of minutes may be calculated at server 4 and retrieved or created at mobile device 5.

In some embodiments, the current jet ski status is displayed to enable direct commands to be sent to mobile device 5 as a function of utilizing geolocation maps and views of the watercraft in their geolocation on mobile device 5, and may enable the screen of mobile device 5 to display different data outputs simultaneously. One portion of the screen may be for input and output management that enables watercraft management to set parameters as well as follow the state of the signals from the jet skis 1a-1e, such as watercraft status, fuel tank level and the like. A second segment may be for more advanced information and ride information, such as last reported latitude and longitude, the state of any external voltage supply, and the strength of communication signals expressed as percentages, for example, the GPS and GSM signals. In a third segment, by way of non-limiting example, counting information such as the number of remaining rides for a particular jet ski, remaining minutes, on a particular ride of a jet ski 1, the number of promo rides over the fleet 1a-1e, or on a jet ski 1a by jet ski 1b basis, parameters for even the use for promo rides, and unauthorized rides. The total minutes that each jet ski 1 was used on a daily basis, no matter the purpose, or even the total minutes according to GPS location. So, by way of example, one can access or display a number of ten minute rides with detailed ride description, once that category is opened with a form that shows each ten minute ride by category or planned category, and whether each ride was in fact 10 minutes or if there was overrun time and to what extent there was overrun time. It should be noted that the database within server 4 may be an actual memory chip, or may merely be access to the cloud for storing of the data remotely in an easily accessible manner.

In summary, as discussed above, the database collects and stores various status, usage and ride related data from every vehicle equipped with module 6. This data may include a vehicle event log, a GPS log, a timing/duration log, a distance/route log, a fuel log, engine parameters which govern service intervals, onboard diagnostics and even various sea water/air condition sensor logs. These would be open condition fluid pressure, atmospheric pressure, even water quality and temperature with the appropriate sensors. The owners or people responsible for jet ski 1 query all relevant data needed to obtain detailed insight into the operational efficiencies of each jet ski 1 on an individual basis, per location basis, or the entire fleet of jet skis 1a-1e to make decisions about productivity and profitability in real-time. The fleet database may serve as an Internet booking engine for jet skis 1a-1e that rent vehicles equipped with modules 6a-6e by location.

The operation of module 6 and server 4 as described above, lend themselves to operation of jet skis 1a-1e in new and unique ways with significant risk elimiation. As seen in FIGS. 1 and 3, each jet ski 1a-1e having a module 6a-6e may have a variety of communication systems such as GSM/Wi Fi 112, antennas, and a SIM CARD 118, or the like. This enables a first jet ski 1a to not only communicate with server 4, but with any of the other jet skis 1b-1e. This is true for each jet ski 1 having a module 6 as described above. This permits the owners or people responsible for jet ski 1, to locate other such equipped vehicles, communicate, share real-time information and to socially network.

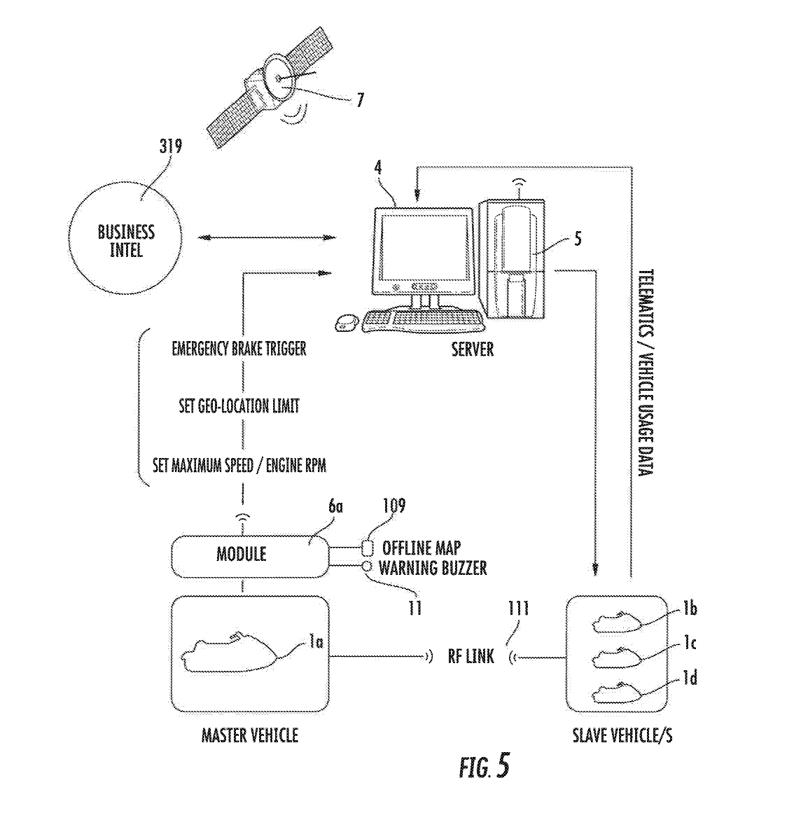

Reference is now made to FIG. 5 in which a mode of operation for jet skis 1a-1e made possible by this intercommunication structure and functionality is provided. As shown in FIG. 5, a single master vehicle 1a controls a number of slave vehicles 1a-1d, for example if running a tour, or trying to navigate through treacherous or restricted areas such as in an ATV or snow mobile embodiment.

A first jet ski 1a is designated the master jet ski 1a. Master jet ski 1a utilizes module 6a to transmit parameters such as a geofence for the trip, a speed limit for the trip, or the like. This may automatically follow by sending a signal to server 4 of the speed and location of master vehicle 1a. Server 4 utilizes this information to send a control signal to each of slave vehicles 1b-1d causing slave vehicles 1b-1d to match the speed and location at a distance (within a predetermined distance of 10 yards by way of non-limiting example) of master jet ski 1a. Utilizing a communication network such as an RF link 111 or the other communication capabilities of module 6, a master jet ski 1a can directly send the control signals in the form of parameters or operational signals to engine control unit 105 through to modules 6b-6d corresponding to respective jet skis 1b-1d.

Master jet ski 1a uses information gathered from GPS satellite 7 and/or an offline map data stored in memory card 109 to determine the position and track slave vehicles 1b-1d; particularly their geolocation. The offline map data stored at memory card 109 may include a customized geofence areas resulting the disabling of any slave vehicle 1b-1d which enters those unauthorized areas beyond the geofence, limiting their speed, through the use of throttle position sensor, and a command signal to engine control unit 105. Additionally, based upon violation of the geofence area, signal from the master module 6a to any slave module 6b-6d may cause the craft to brake or reverse the engine on the respective jet ski by sending a signal to brake and reverse system 117, as a non-limiting example.

The parameters may include setting a maximum speed or engine RPM to be compared with outputs from accelerometer 108, a throttle position sensor 101 or the like.

Each module 6a-6d stores an offline map of the tour/safari ride in respective memory 109. A tour/safari organizer may upload specific routes to microcontroller 103 for specific rides. All routes have unique check sums so server 4 and/or microcontroller 103 can determine whether correct routes are being followed by each jet ski 1A-1D belonging to that safari ride.

Module 6 causes the data of both slave vehicles 1b-1d and master vehicle 1a to be continuously transmitted to server 4 and in preferred embodiments mobile device 5. This data may also be stored in a cloud server 319 in a business intelligence database for purposes of developing the charts and tables discussed above to maximize operational efficiency and business productivity in real-time.

In another embodiment, module 6, particularly microcontroller 103, receives and stores inputs from GPS receiver 110, gyroscope 107, and accelerometer 108 in real-time and then transmits them to server 4 to determine the route taken along the particular tour. As a function, server 4 may then generate parameters to either be stored at memory card 109, or on server 4 itself, to control speed and geoposition of each jet ski 1a-1d along the tour so that a tour may be conducted even without a tour guide. It is contemplated that microcontroller 103 may also be capable of conducting such calculation and control. Additionally, points of interest as a function of speed, elapsed time and/or position may be stored in server 4 and its associated database, whether in the cloud or locally, or in memory 109 to indicate to riders of jet skis 1a-1b that a point of interest such as a mango grove, a fishing area, or even a shore side tiki hut is coming up within a known number of minutes or kilometer and display this information of a respective instrument cluster on each watercraft.

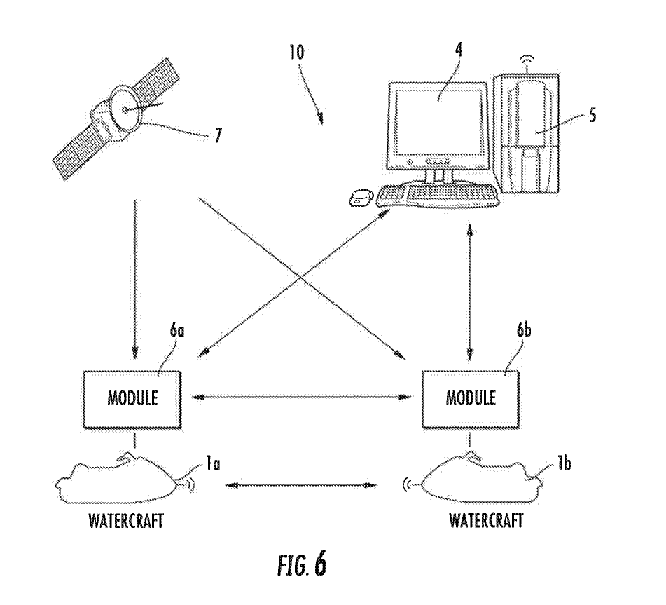

When two or more vehicles are equipped with a module 6, system 10 may be used for safety by preventing contact and collisions by monitoring the speed, manner of operation, direction of travel and position of jet skis 1a-1e relative to each other in real-time. Reference is now made to FIG. 6 in which the operation of system 10 in a method to prevent contact and collisions between jet skis 1a, 1b, each equipped with a respective modules 6a, 6b, in the open water. Jet skis 1a, 1b may communicate between each other using one of the several communication methodologies available as discussed above. By way of non-limiting example, they may communicate utilizing GSM, Wi Fi, or preferably RF technologies. During operation, each module 6a, 6b processes its respective GPS 110, accelerometer 108 and gyroscope 107 sensors to send out speed, position and direction data to server 4 as well as other craft 1a, 1b utilizing module 6a, 6b.

Server 4 analyzes the data from the modules 6a-6e and predicts and projects an anticipated course for each, and if server 4 determines contact or collision is likely, server 4 may apply the speed limit to specific jet skis 1a, 1b or shut one or both jet skis down when necessary. Server 4 may also trigger a watercraft sound warning utilizing warning buzzers 11a, 11b and display the warning on a respective instrument cluster on each watercraft 1a, 1b. In this way, server 4 prevents contact and collisions amongst watercraft having modules 6a, 6b.

This collision preventive system is capable of operation even when server is off-line relative to respective jet skis 1a, 1b. This is done by the direct communication between modules 6a, 6b and the respective modules determining a prospective collision course and creating speed limits and area of operation limits to prevent the predicted contact or collisions. When a first jet ski 1a comes within range of a second jet ski 1b sufficiently close to establish an RF link, they send each other information about speed, bearing and location. Microcontroller 103 then decides whether speed or direction needs to be changed to avoid contact or collision. This RE communication may only occur at ranges of 50 to 500 meters because of the line of sight requirements and signal strength requirements for the RF antennas and transceivers. For those jet skis 1a, 1b equipped with display screens, a warning can be displayed on the screen or a sound warning such as a long continuous beep to alert not only the user of watercraft 1a, but the user of watercraft 1b of a potential contact or collision may be triggered at buzzer 11 in real-time.

It should be noted, that the use of certain sensors can also help rescue efforts for jet ski 1a; increasing safety in another way. By way of example, gyroscope 107 provides an output which allows microcontroller 103 to determine when a jet ski 1 has capsized. Module 6 can also detect impact or unwanted movement by using the data from accelerometer 108. Module 6 backs up the collected data internally in memory card 109 and in this instance, acts as an accident data recorder; the equivalent of the jet ski “black box”. In addition, a signal can be sent to mobile device 5 to alert the person in control of system 10 that one of the user may be in need of help in real-time.

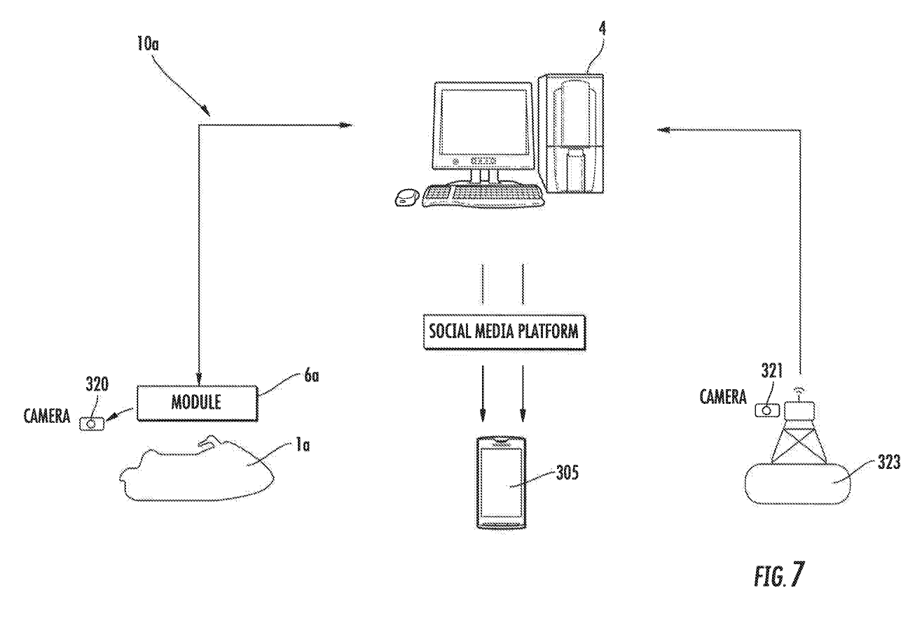

Because module 6a is continuously in communication with server 4, module 6a and in particular jet ski 1a, is capable of operation automatically occurring as a function of the position of watercraft 1a relative to other structures or known areas within the geofence 315, 316. Reference is now made to FIG. 7 in which an embodiment for taking photographs of, and/or from jet ski 1a is provided.

In this embodiment, system 10 includes a camera 320 mounted on a jet ski 1a and under the control of module 6a. A mount 323 such as a buoy, a side road, a canal structure or the like, is provided with a second camera 321. Mount 323 is in communication with server 4 and module 6a. Utilizing communication between module 6a and mount 323, the signal, as a function of relative geolocation, as determined by module 6a and/or server 4, is sent between module 6a and mount 323 causing a trigger signal to be sent to camera 320 and/or camera 321. This results in a photograph of the relative scenery around jet ski 1a when camera 320 is triggered, and of jet ski 1a itself, if camera 321 is appropriately triggered. The photographs, or movies, if a video camera is utilized, are sent to server 4 along with the other data reported at the predetermined time intervals.

This other data may include location, route, speed, water/air data or the like captured by module 6a as discussed above. Server 4 stores the footage and the data associated with the input from the respective cameras 320, 321. This data may then be transferred to a social media platform as known in the art with an invitation sent to the email or other address of a computing device 305 belonging to the user of the jet ski 1a to view the photographs in real-time. The photographs may be associated with the data as collected in a format that provides a narrative regarding the trip associated with the photos. In this way, a history of the trip along with the data regarding location, route, date, time, and weather condition may be provided. This package may be sold or given away as known in the art.

Use of information from all the sensors, particularly when the sensors are in sleep mode, can be used as an anti-theft device. A “sleep” or “lock” command is sent by server 4 to the appropriate jet skis 1a-1d. In this mode, ignition is blocked and microcontroller 103 will set off a buzzer alarm if module 6 detects unauthorized movement. Unauthorized movement may be detected at either server 4 or microcontroller 103. In either implementation GPS coordinates at the moment of locking are stored. Microcontroller 103 periodically samples a GPS value for the location of jet ski 1. Any further GPS geoprint pair is observed while locking is active. If microcontroller 103 and/or server 4 calculates a distance from the locked GPS coordinates and a new GPS coordinate of more than a predetermined distance such as 50 feet, by way of non-limiting example, the alarm is activated at microcontroller 103 and a signal is sent to server 4 to activate an alarm at server 4 as well to then send a signal to mobile device 5 or to the owner of the jet ski over any communication platforms. Microcontroller 103 may also use the signal detection of output by accelerometer 108 to trigger an alarm state as this is a detection that the vehicle is moving other than by waves. It may also be indicative of overly large waves, such as in a severe storm or crash detections such as crash into a dock or crash into some other device.

Anti-theft during sleep mode, when the jet ski 1 is theoretically powered down and the energy consuming sensors and other operating devices such as the transceivers are “off”, external processor interrupts are active to detect possible activity of the gyroscope sensor 107, the key activation and ignition switch, and/or accelerometer 108. If any activity is detected at these sensors during the sleep mode; the processor interrupts and unit automatically exits the sleep mode and enters an active state to report such unexpected activity. Furthermore, as discussed above, during the sleep mode, microcontroller 103 wakes up at regular time intervals, as determined by the user, to check GPS coordinates and other sensor information. Once this data is successfully uploaded to server 4, the unit may then go back to sleep mode if possible or alarm mode as discussed above if a difference in values is detected.

In yet another embodiment, microcontroller 103 monitors the power of the onboard battery and microcontroller 103 and if no power flow is detected by microcontroller 103, module 6 sends a signal to server 4 indicative that someone is disconnecting module 6 from the battery. Furthermore, by detecting any tampering or disconnecting of any sensors, the ECU, the MCU or any other device, microcontroller 103 prevents operation of jet ski 1 by preventing ECU from operating.

What is claimed as new and desired to be protected by Letters Patent is:

1. A system for tracking and remote control of a personal recreational vehicle comprising:
at least two sensors, each sensor sensing at least a respective and distinct one of temperature, pressure, acceleration, geoposition orientation relative to a horizontal plane and communication signal strength;
a microcontroller for receiving inputs from the at least two sensors, and determining whether a change in environmental conditions in which the personal vehicle is operating has occurred, the microcontroller sending an alarm to a user of the personal recreational vehicle if a change in the environmental conditions have exceeded a predetermined value.

2. A system for monitoring and analysis of a personal recreational vehicle comprising:
at least a first sensor and second sensor, the at least first sensor and second sensor outputting a first sensor signal and the at least second sensor outputting a second sensor signal;
a microcontroller unit for receiving the first sensor signal and the second sensor signal and determining a first velocity of the personal recreational vehicle as a function of the first sensor signal and the second sensor signal;
a radio frequency transceiver for periodically outputting the first velocity of the personal recreational vehicle as a first velocity signal, and receiving a second velocity signal from at least a second personal recreational vehicle;
transmitting the second velocity signal to the microprocessing unit;
an engine control unit for controlling a throttle speed of the second personal recreational vehicle to control the speed and direction of the first personal recreational vehicle, and the microcontroller determining whether the first personal recreational vehicle will contact the second personal recreational vehicle as a function of the first velocity signal and the second velocity signal; and
the microcontroller sending a signal to the engine control unit to change the velocity of at least the first personal recreational vehicle to avoid the contact.

3. An anti-theft system for a personal recreational vehicle; the personal recreational vehicle comprising:
a transceiver for receiving a lock signal;
a microcontrol unit
an engine control unit in communication with and controlled by the microcontrol unit;
the microcontrol unit receiving the lock signal from the transceiver and preventing activation of the engine control unit and ignition during a time period indicated by the lock signal.
